(19) United States
(12) Patent Application Publication
(10) Pub. No.: US 2026/0316484 A1
(43) Pub. Date: Oct. 15, 2026

(54) PEN HOLDER, PEN, AND SYSTEM COMPRISING A PEN HOLDER AND A PEN

(71) Applicant: Bleispitz GmbH, Oberhaching (DE)

(72) Inventor: Enno MIEDL, Oberhaching (DE)

(21) Appl. No.: 19/538,395

(22) Filed: Feb. 12, 2026

(30) Foreign Application Priority Data
Feb. 13, 2025 (DE) 102025105395.2

(51) Int. Cl. B43K 23/12; B43K 29/06

(52) U.S. Cl. CPC B43K 23/12; B43K 29/06

(57) ABSTRACT

The present disclosure relates to a pen holder for storing a pen or marker, in particular a deep-hole marker, with a base body, preferably designed in the form of a sleeve, which extends in a longitudinal direction and defines a receiving space for at least partially receiving the pen and has a base body wall. The base body has an insertion opening in the base body wall at a first end of the longitudinal direction for inserting the pen into the receiving space, at least one first coupling element being formed in or on the base body for reversibly fixing the pen in the receiving space, wherein the first coupling element includes or is a magnetic element or a magnet. The present disclosure further relates to a pen and a system comprising the pen holder and the pen.

### TECHNICAL FIELD

The present disclosure relates to a pen holder for storing and transporting a pen or marker, in particular a deep-hole marker, a pen, in particular a deep-hole marker, for the pen holder; and a system comprising the pen holder and the pen.

### PRIOR ART

In the skilled crafts trades and on construction sites, various types of pens, such as deep hole markers or carpenter's pencils, are used on a daily basis for performing marking and labeling work and for taking notes. Here, it is particularly important that the pen is easy to reach and can be operated with one hand to ensure access to the pen even when the user's other hand is occupied with a tool, such as a spirit level, or mounting material.

In addition, the pen should be stored/secured in such a way that it cannot be lost or misplaced, as pens lying around, especially on construction sites, can quickly go missing.

Pen holders, such as those known from DE 695 06 392 T2, have established themselves on the market as a solution to these problems. Such pen holders can be attached to a user's/operator's pocket or belt with a clip, allowing the user to access the pen with one hand.

Conventional pen holders have the disadvantage that the user must turn their gaze toward the pen holder in order to safely insert, store, and lock the pen in the pen holder. Furthermore, the pen can easily fall out of the pen holder, especially if the user leans far forward on a construction site.

To overcome this disadvantage, locking mechanisms have been developed that allow the pen to be locked into the pen holder in a reversible manner. Such locking mechanisms reduce the risk of the pen falling out of the pen holder.

However, the disadvantage of such locking mechanisms is that, especially in the case of pens and pen holders for use on construction sites, they must have a high preload force between the pen and the pen holder in order to ensure that the pen is held reliably in the pen holder.

Such a high preload force has the disadvantage that the user must hold the pen holder in order to pull the pen out of it, as otherwise the pen holder may detach from the user's pants. Furthermore, the pen holder must be held in place in order to overcome the preload force when inserting the pen into the pen holder, as a pants pocket hem cannot reliably absorb the high insertion force required to overcome the preload force and thus lock the pen into the pen holder. Thus, the pen holder can only be operated with one hand to a limited extent, and the ease of use for the user is significantly reduced.

### BRIEF DESCRIPTION OF THE INVENTION

The purpose of the present disclosure is therefore to provide a pen holder, a pen, and a system consisting of the pen and the pen holder, which overcome or at least reduce the disadvantages of the prior art. Specifically, the purpose of the present disclosure is to provide a pen holder that, on the one hand, reliably and securely holds the pen in place even when used on a construction site and, on the other hand, ensures easy one-handed operation. Furthermore, it is the object to provide a corresponding pen that can be securely and reliably fixed in the pen holder. Finally, it is the purpose of the present disclosure to provide a system consisting of the pen holder and the pen.

These tasks are solved by a pen holder, by a pen, by a system comprising the pen holder and the pen, and by a use of the pen holder, pen, and system as disclosed and claimed herein. Advantageous further developments are part of the subclaims and/or are described below.

Specifically, the task is solved by a pen holder for storing a pen/marker, in particular a felt-tip pen or paint marker or deep-hole marker or carpenter's pencil, with a base body, preferably in the form of a sleeve, that extends in a longitudinal direction and defines a receiving space for at least partially accommodating the pen and has a base body wall. On a first end of the longitudinal direction resp. in a longitudinal direction the base body has an insertion opening in the base body wall in order to insert the pen into the receiving space. At least one first coupling element is formed in or on the base body, preferably, in or on an end portion of the base body facing the insertion opening (i.e., close to the insertion opening), to reversibly fix the pen in the receiving space, the coupling element including or being a magnetic element or magnet.

In other words, the task is solved by a pen holder, which is designed and configured to hold at least one pen in a reversible manner. The pen holder has a base body that extends in the longitudinal direction, preferably at least in sections in a cylindrical shape. Alternatively, or additionally, the base body in sections may be designed in a conical and/or frustoconical shape. The pen holder preferably has a (much) greater extension in the longitudinal direction than in a width direction/radial direction/circumferential direction/transverse direction oriented normally to the longitudinal direction. The base body may preferably have a sleeve shape or be designed in the form of a sleeve. In other words, the base body may have a type of one-sided closed tube geometry with a comparatively thin base body wall. The base body or base body wall delimits the receiving space of the pen holder.

The receiving space is accessible through the insertion opening/connected to an environment surrounding the pen holder. The insertion opening is formed on one of the ends of the pen holder in the longitudinal direction. In particular, the insertion opening may be formed on an end face/end side of the base body or may essentially form the end face/end side. The insertion opening is the opening through which the pen can be inserted/introduced/put/pushed into the receiving space, at least in sections. Preferably, the insertion opening is the only opening connecting the receiving space to the environment surrounding the pencil holder. Alternatively, embodiments with at least one drainage opening are conceivable. Drainage openings are particularly conceivable when using a pencil.

The at least one first coupling element is formed on the first end/end portion, i.e., adjacent to/near the insertion opening. The first coupling element is provided and configured to reversibly fix/lock the pen in the receiving space in such a way that at least the writing tip is received in the receiving space. In case the pen is a deep hole marker, the first coupling element is provided and designed to reversibly fix the pen in the receiving space such that the marking tip, consisting of the writing tip and a shaft connecting the writing tip to the base body, is preferably completely accommodated in the receiving space.

The first coupling element is or contains at least one magnetic element.

A magnetic element is to be understood as an element that is attracted or can be attracted by a magnet. In other words, a magnetic element is a ferromagnetic and/or paramagnetic element.

The magnetic element can be made of iron, cobalt, nickel, or a suitable alloy, for example.

Alternatively, the first coupling element is or contains at least one magnet.

A magnet is to be comprehended as an element that generates a magnetic field in its surroundings. In this magnetic field, certain other magnetic elements or magnets are attracted or repelled by the magnet.

The at least one first coupling element can be formed fixed or in a detachable manner on or in the base body. For example, the first coupling element can be glued to the base body. Alternatively, the first coupling element can be cast with or in the base body. Further alternatively, the first coupling element can be accommodated in a receiving space provided for the first coupling element. For example, the first coupling element can be crimped or glued in the receiving space.

The at least one first coupling element may be formed on or in an outer side of the base body facing away from the receiving space. Alternatively, it is conceivable that the first coupling element is formed in or on an inner side of the base body. Further alternatively, the at least one first coupling element may be formed in the base body wall or in a protrusion or indentation of the base body wall.

The use of the magnet or magnetic element as the first coupling element enables easy handling, as the pen adheres/is fixed quickly and reliably to/in the pen holder without the user having to manually turn or push it. This reduces the effort required to pull or put away a pen in the pen holder and at the same time offers improved user-friendliness. Furthermore, the magnetic first coupling element enables a stable connection that does not lose its adhesive force even with frequent use and reliably holds the pen in place. The magnetic principle moreover fixes the pen in the pen holder with minimal mechanical stress, which extends the service life of the components and makes the pen holder more comfortable to use. Furthermore, when operating the pen holder with one hand, for example, the user can simply insert the tip of the pen into the insertion opening of the pen holder and then drop it, while still being sure that the pen is reliably fixed in the pen holder.

In one aspect, the at least one coupling element may be distributed, preferably evenly, over a circumference or a circumferential section of the base body.

In other words, the single first coupling element may surround the base body and/or the receiving space evenly around its circumference. Alternatively, a plurality of first coupling elements may be distributed in a uniform manner over the circumference of the base body. Uniform distribution of a plurality of first coupling elements means that a constant distance in the circumferential direction of the base body resp. the base body wall is formed between adjacent first coupling elements. In other words, an enclosed angle or arc length between adjacent first coupling elements can be constant over the circumference of the base body. In still other words, a separation/separation angle of the coupling elements in or on the base body wall resp. over the circumferential extension of the base body wall may be constant.

The uniform formation of the at least one first coupling element distributed over the circumference of the base body ensures that the pen is reliably fixed in the pen holder. Specifically, a user does not have to pay attention to the correct alignment of the pen in relation to the pen holder, but can simply slide the pen into the pen holder blindly. The uniform circumferential formation of the at least one first coupling element ensures a reliable magnetic connection between the pen and the pen holder in a variety of rotational positions. Preferably, this allows for (automatic) self-alignment of the pen in the receiving space of the pen holder.

In another aspect, the preferably exactly one first coupling element may be designed as a ring-shaped coupling element, the coupling element enabling to radially enclose/surround the receiving space in sections.

In other words, the preferably exactly one first coupling element can be designed as a ring-shaped or washer-shaped coupling element, which radially surrounds or delimits the receiving space in a local section in the longitudinal direction of the receiving space.

Such a design of the first coupling element ensures that the pen holder is easy to assemble and that the pen is held even more securely in the pen holder. Specifically, the operator no longer has to pay attention to the correct alignment of the pen in relation to the pen holder, but can simply slide the pen into the pen holder blindly. The ring-shaped design of the at least one coupling element ensures a reliable magnetic connection between the pen and the pen holder in any rotational position.

In another aspect, the polar alignment of the first coupling element may be in the longitudinal direction. In other words, the north pole of the first coupling element may be oriented in the positive longitudinal direction and the south pole of the first coupling element may be oriented in the negative longitudinal direction. Of course, the polar alignment may also be mirror-inverted.

Alternatively, it is conceivable to design the polar alignment of the first coupling element normal to the longitudinal direction. Such a polar alignment normal to the longitudinal direction allows automatic positioning of the pen in the pen holder.

In another aspect, the first coupling element can be firmly fixed or detachably fixed to the base body via a first fixing element, preferably via a thread. Alternatively, embodiments are also conceivable in which the fixing element is formed separately from the base body.

In other words, the first fixing element can be designed to fix the first coupling element to the base body. The first fixing element can be provided and designed to connect the first coupling element firmly to the base body. Examples of a firm connection between the first fixing element and the (remaining) base body are welding, gluing, forming, or the like.

Alternatively, the first fixing element may be provided and designed to be detachably fixed to or with the base body. Examples of a detachable connection between the first fixing element and the base body are a thread, preferably an external thread on the base body and an internal thread in the first fixing element, a plug connection, a snap connection, a fit, or the like.

In another aspect, the first fixing element may comprise or be the insertion opening of the base body.

In other words, the first fixing element may be formed on the base body in such a way that it is formed in or on the first end of the base body, or forms the first end of the base body (completely). The first fixing element may comprise or form the insertion opening.

By designing the first fixing element in this way, the first coupling element can be formed in the immediate vicinity of the insertion opening. Furthermore, mounting the first coupling element on the base body can be simplified.

Preferably, the first coupling element can be clamped to the base body by the first fixing element/fixed by a clamping force. In other words, the first fixing element can fix the first coupling element by means of a clamping force.

In one specific embodiment, the first coupling element can be pushed onto the base body in a first step via the external thread of the base body, and then, in a second step, the first fixing element can be screwed onto the external thread of the base body until the first fixing element fixes the first coupling element on the base body in a force-fitting and form-fitting manner.

In a further aspect, a fastening clip can be formed on the base body wall to fix the pen holder to a pocket or belt of the user.

In other words, the fastening clip can be formed on the outer surface/outer circumferential surface of the base body wall. The fastening clip can be designed as a spring element that exerts a spring force against the base body wall. In other words, the fastening clip is preferably preloaded against the base body wall so that a pants pocket edge, in particular a ruler pocket edge, or a belt can be clamped between the fastening clip and the base body wall, so that the pen holder can be firmly fixed to a pants pocket or a belt.

Preferably, the fastening clip is formed in one piece with the base body wall.

It is particularly preferable for first barbs or prongs to be formed on the inside of the fastening clip facing one of the base body walls.

It is further preferable for second barbs or prongs to be formed on the base body wall facing the fastening clip. The first barbs and the second barbs can be arranged alternately in the longitudinal direction.

In a further aspect, at least one grip element may be formed on the base body wall. When the pen is pulled out of the pen holder, the at least one grip element can act as a force application point to overcome the fixing force of the coupling element, especially during one-hand operation.

In a further aspect, two grip elements may be formed on the base body, wherein the two grip elements may be arranged at an angle offset to each other in the longitudinal direction when viewed from above.

The two grip elements may be identical and/or symmetrical, in particular mirror-symmetrical, to each other.

Furthermore, the two grip elements may be preferably formed symmetrically to a first plane of symmetry of the fastening clip on the outer wall.

In other words, two grip elements can extend radially outward from the base body wall. The two grip elements can be formed in the same position in the longitudinal direction.

The first symmetry plane of the fastening clip can include a fastening clip center fiber and the pen holder center fiber. In other words, the first plane of symmetry can extend centrally through the base body and the fastening clip in the longitudinal direction. The two grip elements are preferably arranged and formed symmetrically, preferably mirror-symmetrically, with respect to the plane of symmetry.

It is particularly preferred that the two grip elements extend away from the base body in an ear-shaped manner when viewed from above.

Alternatively, the grip element may be designed as a circumferential flange, a partially circumferential flange, a funnel, individual lugs or ribs distributed around the circumference of the pencil holder, or similar.

Furthermore, the task of the present disclosure is solved by a pen, in particular a deep-hole marker or felt-tip pen or paint marker or carpenter's pencil, which may also be claimed independently, the pen including a second coupling element. The second coupling element includes or is a magnetic element or a magnet, the second coupling element being preferably designed to be magnetically compatible with the first coupling element.

The second coupling element is provided and configured to fix the pen reversibly in the receiving space such that at least the writing tip is held in the receiving space. In case the pen is a deep-hole marker, the second coupling element is provided and configured to reversibly fix the pen to or in the pen holder in such a way that the marking tip is accommodated, preferably completely, in the receiving space.

The second coupling element is or contains at least one magnetic element.

Alternatively, the second coupling element is or contains at least one magnet.

The at least one second coupling element may be formed on or in the pen in a fixed or detachable manner. For example, the first coupling element may be glued to the pen. Alternatively, the first coupling element may be molded with or in the pen, in particular in a pen housing.

The at least one second coupling element may be formed on or in an outer side of the pen resp. the pen housing facing away from a refill holder space. Alternatively, it is conceivable that the second coupling element is formed in or on an inner side of the refill holder space. Further alternatively, the at least one second coupling element may be formed in the pen housing wall.

The use of the magnet or magnetic element as a second coupling element enables easy handling, as the pen adheres quickly and reliably to/in the pen holder without the need for manual twisting or pushing. This reduces the effort required to pull or put away the pen in the pen holder and at the same time offers improved user-friendliness. Furthermore, the magnetic second coupling element enables a stable connection that does not lose its adhesive force even with frequent use and reliably holds the pen in place. Thanks to the magnetic principle, the pen is moreover secured in the pen holder with minimal mechanical stress, which extends the service life of the components and makes the pen more comfortable to use. Furthermore, when operating the pen with one hand, for example, the user can simply insert the tip of the pen into the insertion opening of the pen holder and then drop it, while still being sure that the pen is reliably fixed in the pen holder.

Magnetic compatibility of the first coupling element and the second coupling element means that the first coupling element and the second coupling element attract each other magnetically in a state in which the pen is inserted into the pen holder.

In one aspect, the second coupling element may be formed in or on a grip portion of the pen.

In other words, the pen may include a grip portion that is provided and configured to be gripped by the user. The grip portion may include or accommodate and/or confine the second coupling element.

In one aspect, the at least one second coupling element may be distributed, preferably uniformly, over a circumference or a circumferential section of the pen.

In other words, the second coupling element may evenly surround the pen housing and/or the refill holder space circumferentially. Alternatively, several coupling elements may be distributed uniformly over the circumference of the pen housing. By a uniform distribution of plural second coupling elements it is to be understood that a constant distance is formed between adjacent second coupling elements in the circumferential direction of the pen housing resp. the pen housing wall. In other words, an enclosed angle or arc length between adjacent second coupling elements can be constant over the circumference of the pen housing. In still other words, a separation/separation angle of the coupling elements in or on the pen body wall resp. across the pen body wall may be constant.

The uniform formation of the at least one second coupling element distributed over the circumference of the pen body ensures that the pen is reliably fixed in the pen holder. Specifically, the user does not have to pay attention to the correct alignment of the pen in relation to the pen holder, but can simply slide the pen into the pen holder blindly. The uniform circumferential formation of the at least one second coupling element ensures a reliable magnetic connection in a variety of rotational positions between the pen and the pen holder. Preferably, in this way (automatic) self-alignment of the pen in the receiving space of the pen holder may be accomplished.

In a further aspect, the preferably exactly one second coupling element can be designed as an annular coupling element, the coupling element being suited to radially enclose/surround the pen body in sections, in particular in a longitudinal section of the pen.

In other words, the preferably exactly one second coupling element can be formed as a ring-shaped or washer-shaped coupling element, which radially surrounds or delimits the refill holder space in a local section in the longitudinal direction of the refill holder space.

Such a design of the second coupling element ensures, on the one hand, easy assembly of the pen and, on the other hand, that the pen is held even more reliably in the pen holder. Specifically, the user no longer has to pay attention to the correct alignment of the pen in relation to the pen holder at all, but can simply slide the pen into the pen holder blindly. The ring-shaped design of the at least one second coupling element ensures a reliable magnetic connection between the pen and the pen holder in any rotational position.

In another aspect, the polar alignment of the second coupling element may be in the longitudinal direction. In other words, the north pole of the second coupling element may be oriented in the positive longitudinal direction and the south pole of the coupling element may be oriented in the negative longitudinal direction. Of course, the polar alignment may also be mirror-inverted.

Preferably, the polar alignment of the first coupling element corresponds to the polar alignment of the second coupling element. In particular, the polar alignment of the first coupling element relative to the longitudinal direction preferably corresponds to the polar alignment of the second coupling element relative to the longitudinal direction.

Alternatively, it is conceivable to design the polar alignment perpendicular to the longitudinal direction. Such a polar alignment perpendicular to the longitudinal direction allows for automatic positioning of the pen in the pen holder.

In a further aspect, the second coupling element can be fixed to the pen in a firm or detachable manner via a second fixing element, preferably by means of a thread.

In other words, the second fixing element can be configured to fix the second coupling element to the pen or to the pen housing. The second fixing element can be provided and configured to connect the second coupling element firmly and inextricably to the pen. Examples of a permanent connection between the second fixing element and the pen housing include welding, gluing, forming, or the like.

Alternatively, the second fixing element may be designed and configured to be detachably fixed to the pen housing. Examples of a detachable connection between the second fixing element and the pen housing include a thread, preferably an external thread on the pen housing and an internal thread in the second fixing element, a plug connection, a snap connection, a fit, or the like.

The first fixing element and/or the second fixing element can be formed, for example, as a sleeve or a ring or a nut or the like.

In one aspect, an internal or external circumferential groove can be formed in the first fixing element and/or in the second fixing element to receive the first coupling element or the second coupling element in a form-fitting and/or force-fitting manner.

In another aspect, the second fixing element may include or be a stop for the pen on the pen holder.

In other words, the second fixing element may be formed on the pen housing in such a way that it limits the grip portion of the pen toward a writing tip.

By designing the second fixing element in this way, the second coupling element can be formed in the immediate vicinity of the insertion opening of the pen holder, so that a high magnetic attractive force can be achieved between the first coupling element and the second coupling element.

Preferably, the second coupling element can be clamped to the pen housing by the second fixing element. In other words, the second fixing element can fix the second coupling element in place by means of a clamping force.

In a further aspect, the first fixing element and/or the second fixing element can be made of a material that is permeable to magnetic fields, i.e., a material such as plastic.

In a further aspect, the holding or fixing force of the pen in the pen holder can be adjusted by selecting a dimension, for example, the width or the length of the first fixing element and/or the second fixing element.

The task of the present disclosure is further solved by a system consisting of the pen holder according to one of the above aspects and the pen, in particular a deep hole marker, according to one of the above aspects, wherein the first coupling element and the second coupling element are releasably magnetically connected to each other in an inserted state of the pen in the pen holder, i.e., they attract each other magnetically, and reversibly fix/hold the pen in the pen holder, preferably with a predetermined/preset fixing force.

In one aspect, the first coupling element and the second coupling element may form a sealing device or, in conjunction with the first and/or second fixing element, form a sealing device which is provided and designed to seal the receiving space toward an environment surrounding the system.

Sealing means that when the pen is inserted into the pen holder, no foreign bodies, such as dirt particles, can penetrate the receptacle.

Preferably, and in particular in connection with a felt-tip pen or paint marker, the seal may also be essentially airtight.

In one aspect, the first coupling element and the second coupling element can preferably lie flat on top of each other when the pen is inserted into the pen holder, thus sealing the receiving space from the environment. A sealing surface between the first coupling element and the second coupling element can be formed normally to the longitudinal direction or conically at an angle to the longitudinal direction.

Alternatively, the sealing surface can be formed between the first fixing element and the second fixing element.

Further alternatively, the sealing surface can be formed between the first fixing element and the pen housing.

Further alternatively, the sealing surface can be formed between the second fixing element and the base body.

Further alternatively, the sealing surface may be formed between the base body and the pen housing.

In a further aspect, a sealing lip, sealing edge, or the like may be formed in place of the sealing surface.

In a further alternative embodiment of the system, it is provided that the magnetic fixing of the pen in the base body of the pen holder takes place not (or not exclusively) via the grip portion, but via the writing tip and/or the shaft. The pen, in particular designed as the deep-hole marker, comprises the writing tip and the shaft connecting the writing tip to the base body of the pen.

In this embodiment, the writing tip and/or the shaft are made at least in sections of a metallic material or formed with a metallic element, which constitutes a magnetic element. In this context, the magnetic element is to be understood as a (ferro-)magnetic element (for example made of iron, cobalt, nickel, or an alloy) which is attracted by a magnet. Consequently, in this configuration, the writing tip and/or the shaft form the second coupling element or a component thereof. Alternatively, the shaft can have a sleeve or a ring which is formed as the magnetic element.

The base body of the pen holder has the first coupling element, which is formed as a magnet. Deviating from the preceding embodiments, the first coupling element is here preferably not arranged immediately at the insertion opening, but positioned deeper in the receiving space. For example, the first coupling element can be arranged in the area of the second, tapered portion of the base body or at an end/portion of the receiving space opposite the insertion opening. The first coupling element can be formed as a ring-shaped coupling element which encloses the receiving space in an area in which the shaft of the pen comes to lie in the inserted state. Alternatively, the magnet can be arranged at the bottom of the receiving space in order to interact with the writing tip. Furthermore, point-shaped, linear, or partially circular configurations of the magnet are also conceivable. The first coupling element can be integrated, pressed, or glued into the base body wall, or formed on an inner side of the base body.

In an inserted state of the pen into the receiving space, the magnetically formed writing tip or the magnetic shaft plunges into the effective range of the magnet (of the first coupling element) in the pen holder. The first coupling element (the magnet in the base body) and the second coupling element (the metallic writing tip/shaft) are magnetically compatible and attract each other. Thereby, the pen, and in particular the marking tip, is reversibly fixed in the pen holder. This arrangement has the advantage that the pen is guided over a longitudinal extension in the longitudinal direction and the holding force (“fixing force”) acts directly in the area of the sensitive writing tip or the stable shaft, which ensures secure reception even in the case of strong vibrations. In addition, automatic positioning of the pen deep in the holder is supported. Furthermore, depending on the specific design, an additional magnetic element can be dispensed with.

The task of the present disclosure is further solved, according to an aspect that may be claimed independently, by using a/the pen holder, in particular according to one of the above aspects, for the purpose of receiving, in particular sealing manner, a pen, in particular according to one of the above aspects, in the receiving space of the pen holder.

According to a preferred aspect of use, the first coupling element of the pen holder forms a sealing portion or a component of the sealing portion which receives the pen, in particular the second coupling element of the pen, in a sealing manner. Thus, the first and second coupling elements preferably serve not only for magnetic attachment but also for sealing. Preferably, according to the use, the first coupling element of the pen holder is in direct or indirect sealing/sealed engagement with the second coupling element of the pen, so that dirt is prevented from entering the receiving space of the pen holder.

By indirect engagement in this context it is to be comprehended that one or more elements, for example in the form of one or more fixing elements and/or sealing lips/sealing edges, may be formed between the first coupling element and the second coupling element.

The task of the present disclosure is further solved, in accordance with an aspect that may be claimed independently, by using a pen, in particular according to one of the above aspects, for, in particular, sealing/sealed, reception in a receiving space of a pen holder, in particular according to one of the above aspects.

According to a preferred aspect of use, the second coupling element of the pen forms a sealing portion or a component of the sealing portion, which is or is received in a sealing manner on the pen holder, in particular the first coupling element of the pen holder. Thus, the first and second coupling elements preferably serve not only for magnetic fastening, but also for sealing. Preferably, according to the use, the first coupling element of the pen holder is in direct or indirect sealing/sealed engagement with the second coupling element of the pen, so that dirt is prevented from entering the receiving space of the pen holder.

In an aspect that may also be claimed independently, the pen may have a detachable, essentially cylindrical cap at the end facing away from the writing tip. Correspondingly, the disclosure also relates to a pen that has a removable, essentially cylindrical cap at the end opposite the writing tip. The cap can, for example, function as a push button for advancing a mechanical pencil of the pen and/or close the pen. The cap can be placed or screwed on the end of the pen. The cap can have a sharpening device for a refill of the pen on the inside of the cap.

The sharpening device may have a substantially cylindrical geometry, which is provided and configured to be inserted into a refill holder.

The cap may be riffled around its circumference, the riffling being provided and designed to prevent an operator from slipping when unscrewing the cap from the pen.

A sharpening device pictogram may be formed on the cap cover, i.e., a top or bottom surface of the cap.

The sharpening device may be formed on an inner side of the cap cover.

### BRIEF DESCRIPTION OF THE FIGURES

FIG. 1 is a side view of a pen holder according to the disclosure;

FIG. 2 is a perspective view of the pen holder according to the disclosure;

FIG. 3 is a perspective view of the pen holder according to the disclosure in a first alternative embodiment;

FIG. 4 is a perspective view of the pen holder according to the disclosure in a second alternative embodiment;

FIG. 5 is a perspective view of the pen holder according to the disclosure in a second alternative embodiment;

FIG. 6 is a side view of a pen according to the disclosure in the form of a deep-hole marker;

FIG. 7 is a perspective view of the pen according to the disclosure;

FIG. 8 is another side view of the pen according to the disclosure in a first alternative configuration;

FIG. 9 is a side view of the system according to the disclosure consisting of the pen

FIG. 10 is a top view of a cap of the pen;

FIG. 11 is a perspective view of the cap;

FIG. 12 is another side view of the pen according to the disclosure in a second alternative configuration; and

FIG. 13 is a side view of the system according to the disclosure consisting of the pen holder and the pen in the second alternative configuration.

### DESCRIPTION OF THE EMBODIMENTS

Subsequently, embodiments of the present disclosure are described on the basis of the accompanying figures.

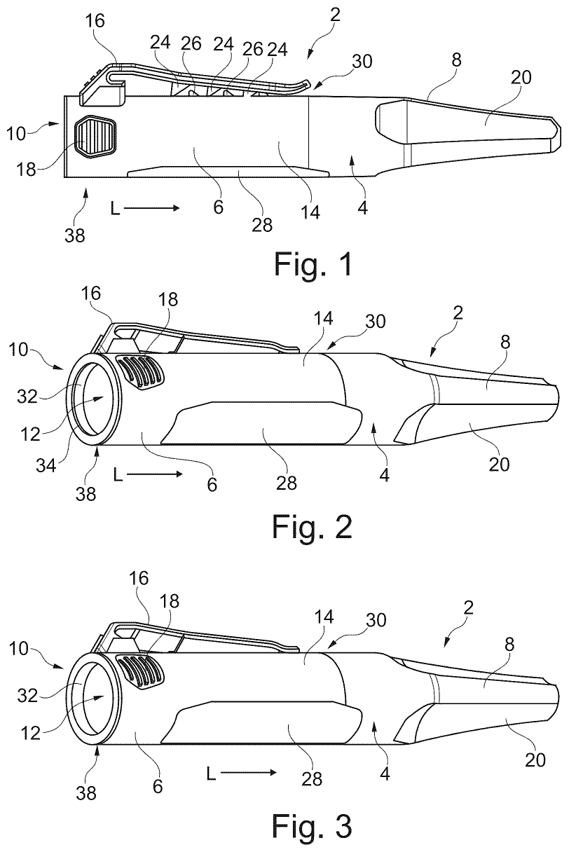

FIGS. 1 to 5 show a pen holder 2 according to the disclosure for storing a pen, in particular a deep-hole marker or a felt-tip pen or a paint marker or a carpenter's pencil.

The pen holder 2 comprises a base body 4 which extends in a longitudinal direction L. The base body 4 comprises a first, essentially tubular portion 6 and a second, tapered portion 8. The first portion 6 is formed in one piece. The first portion 6 of the base body 4 has an essentially circular insertion opening 10 on a first end face. The insertion opening 10 is provided and designed to allow the pen (see 36 in FIG. 6) to be inserted at least partially into a receiving space 12. Instead of the first portion 6 and the second portion 8, a single-piece portion may also be formed.

A fastening clip/holding clip 16 is provided and formed on an outer surface 14 of the first portion 6 of the base body 4 to fix the pen holder 2 to a belt, a (pants or folding rule) pocket, or any other suitable object belonging to a user of the pen holder 2.

Adjacent to the insertion opening 10, two grip surfaces 18 are formed on the outer surface 14 at a first end 38 of the base body 4, radially opposite each other. The grip surfaces 18 are locally roughened or riffled surfaces. Furthermore, a labeling field 28 is formed in the outer surface 14. The labeling field 28 is a recess in the outer surface 14, which is provided and designed to be labeled or affixed with stickers.

The second portion 8 of the base body 4 has tube-shaped recesses 20, which are designed and formed to reduce rotation of the pen holder 2, for example inside the user's pocket. Furthermore, the recesses 20 function as recessed grips that can be gripped when operating with two hands.

The holding clip 16 is formed in one piece with the first portion 6 of the base body 4. First barbs 24 are formed on the holding clip 16 on a side facing the first portion 6. Second barbs 26 are formed on the base body 4 in the longitudinal direction L, alternating with the first barbs 24. The first barbs 24 and the second barbs 26 securely fix the pen holder 2 via the holding clip 16 and prevent the pen holder 2 from slipping or falling out of, for example, a user's pocket.

The first portion 6 and the second portion 8 are connected/coupled to each other in a connecting area 30. The connecting area 30 can be designed as a force-fit and/or form-fit connection between the first portion 6 and the second portion 8, the second portion 8 being partially inserted into the first portion 6. In other words, the first portion 6 and the second portion 8 can be glued, pressed, shrunk, welded, or similar to each other. For this purpose, the second portion 8 is formed with a reduced outer diameter in the connecting area 30, so that the outer contour of the pen holder 2 is essentially stepless in the connecting area 30. Of course, also the first portion 6 can be partially inserted into the second portion 8, or the first portion 6 and the second portion 8 can be connected to each other at contacting end faces. A one-piece configuration of the base body is also conceivable.

Furthermore, embodiments are conceivable in which the connection area 30 is formed as a reversibly connected connection area 30 so that it can be connected and disconnected by a user. Preferably, the connection area 30 can be designed with a bayonet lock for this purpose.

Adjacent to the insertion opening 10, a ring-shaped first coupling element 32 is formed. In the first embodiment shown in FIG. 2, the first coupling element 32 is pressed and/or glued into the first portion 6. In the embodiment shown here, the first coupling element 32 is a ring-shaped magnet, with the north-south polar alignment of the magnet aligned in the longitudinal direction L. The first coupling element 32 is firmly connected to the first portion 6 by a disc-shaped first fixing element 34. In the embodiment shown here, the first fixing element 34 covers the first coupling element 32 towards the insertion opening 10. In this way, the first fixing element 34 protects the first coupling element 32 from damage.

FIG. 3 shows a first alternative embodiment of the pen holder 2, which essentially corresponds to the first embodiment. The first alternative embodiment of the pen holder 2 differs from the first embodiment only in the design of the first coupling element 32. In the first alternative embodiment, the first fixing element 34 is omitted and the first coupling element 32 forms the insertion opening 10 of the receiving space 12. The first coupling element 32 is pressed and/or glued into the inner wall of the receiving space.

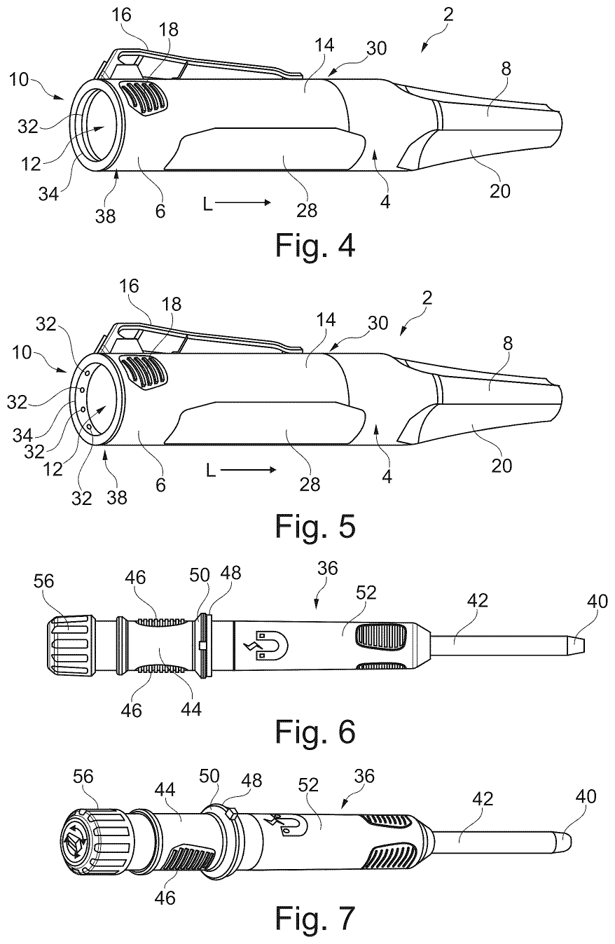

FIG. 4 shows a second alternative embodiment of the pen holder 2, which essentially corresponds to the first embodiment and the first alternative embodiment. The second alternative embodiment of the pen holder 2 also differs from the first embodiment only in the design of the first coupling element 32. In the second alternative embodiment, the first fixing element 34 extends into the receiving space and the first coupling element 32 is accommodated in the first fixing element 34, in this case in a groove. The first fixing element is pressed and/or glued into or onto the inner wall of the receiving space.

FIG. 5 shows a third alternative embodiment of the pen holder 2, which essentially corresponds to the second alternative embodiment. The third alternative embodiment of the pen holder 2 merely is distinguished from the second alternative embodiment in the formation of the first coupling element 32. In the third alternative embodiment, a plurality of first coupling elements 32 are formed as points in the first fixing element 34. The plurality of first coupling elements 32 are accommodated in the first fixing element 34 being distributed regularly around the circumference. In the third alternative embodiment shown here, the plurality of first coupling elements 32 are oriented toward the receiving space 12. Of course, the plurality of first coupling elements 32 can also be accommodated in an end face (in the longitudinal direction L in the top view). Further alternatively, the plurality of first coupling elements 32 may be oriented toward the base body wall 62.

FIG. 6 and FIG. 7 show the pen 36 according to the disclosure in a first configuration. The pen 36 is a deep hole marker in a configuration as a mechanical pencil with a feed mechanism and includes a writing tip 40, a shaft 42 connected to the writing tip, and a grip portion 44. The grip portion 44 is provided and configured to be gripped by a user. The grip portion 44 includes grip surfaces 46. The grip surfaces 46 are local ribbing which facilitate grip for the user and prevent slipping. A second coupling element 48 is formed on the grip portion 44. The second coupling element 48 is designed as a magnetic ring which radially surrounds the grip portion 44. The second coupling element 48 is formed on an end portion of the grip portion 44 facing the shaft 42.

The second coupling element 48 is fixed to the grip portion 44 by way of a second fixing element 50. The second fixing element 50 is a circumferential edge on the grip portion 44. In the embodiment shown here, the second fixing element 50 is formed in one piece with the grip portion 44.

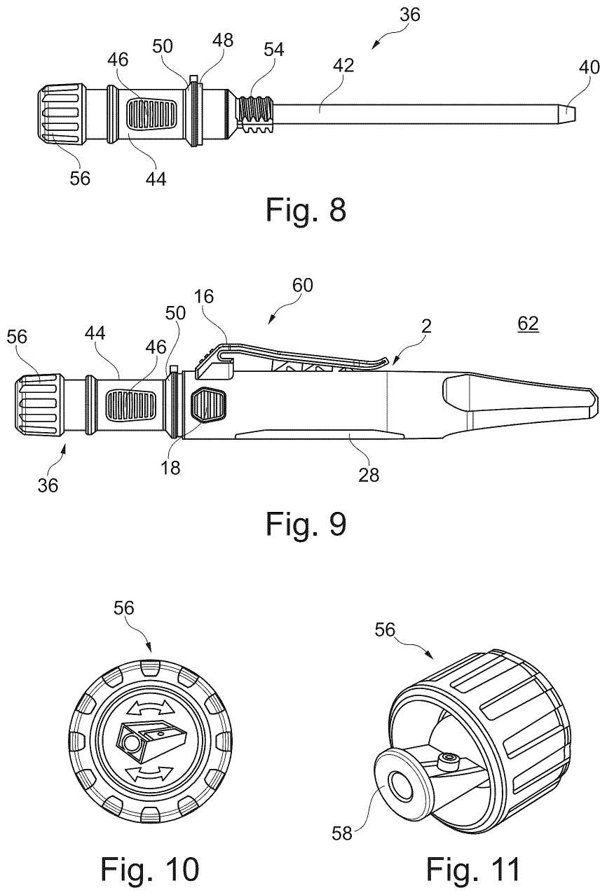

The shaft 42 is partially enclosed/surrounded by a sleeve 52. The sleeve 52 is detachably fixed to the grip portion 44 via a thread 54 (see FIG. 8). Thus, two different deep hole marking depths can be set by screwing the sleeve 52 onto or off the shaft 42.

A cap 56 is formed on one end of the grip portion 44 facing away from the shaft 42. The cap 56 serves as a button for activating or operating the feed mechanism. The cap 56 can be pulled off or unscrewed from the grip portion 44. As shown in FIG. 11, a sharpener 58 is formed on an inner side of the cap 56. The sharpener extends into the space formed by the cap 56 and, in a mounted state of the cap 56, is received on the pen 36 in the grip portion 44 of the pen 36.

FIG. 9 shows the disclosed system 60 consisting of the pen 36 and the pen holder 2 in a state in which the pen 36 is inserted into the pen holder 2. In the embodiment shown here, the second coupling element 48 of the pen 36 rests against the first coupling element 32 of the pen holder 2 in the inserted state. The first coupling element 32 and the second coupling element 48 adhere magnetically to each other, thereby fixing the pen 36 in the pen holder 2. The first coupling element 32 and the second coupling element 48 adhere to each other such that the receiving space 12 is sealed against an environment 64 surrounding the system. Thus, the first coupling element 32 and the second coupling element 48 together function as a sealing device for the receiving space.

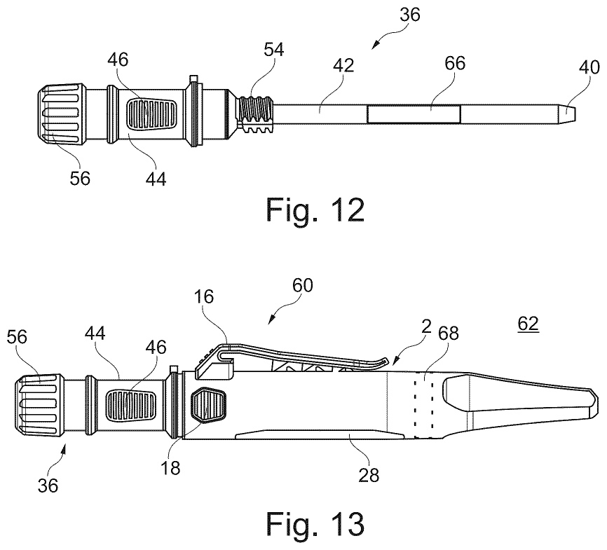

FIG. 12 shows the pen 36 in a side view. The structure corresponds essentially to the embodiment shown in FIG. 6, wherein the pen 36 comprises a writing tip 40, a shaft 42, and a grip portion 44 with grip surfaces 46 as well as a cap 56. In contrast to the preceding embodiments, the second coupling element 66 is hereby formed on the shaft 42 of the pen 36. The second coupling element 66 is formed as a sleeve or coating made of a magnetic or magnetizable material (for example metal), which circumferentially encloses the shaft 42 in a defined longitudinal section. The second coupling element 66 is thereby arranged spaced apart from the grip portion 44 in the longitudinal direction.

FIG. 13 shows the system 60 in a side view, wherein the pen 36 is fully inserted into the pen holder 2. On its outer side, the pen holder 2 has the holding clip 16, the grip surfaces 18, as well as the labeling field 28. The pen holder 2 includes a first coupling element 68, which in this embodiment is arranged inside the base body, spaced apart from the insertion opening (shown in dashed lines in FIG. 13). The first coupling element 68 is designed as a magnet or a magnetic arrangement, which is integrated in the base body wall or on an inner side of the receiving space.

The position of the first coupling element 68 in the longitudinal direction of the pen holder 2 corresponds to the position of the second coupling element 66 on the shaft 42 of the pen 36. In the inserted state shown in FIG. 13, the first coupling element 68 and the second coupling element 66 thus lie opposite each other or in overlap radially, separated by the base body wall or directly in the receiving space. Due to the magnetic attractive force between the first coupling element 68 and the second coupling element 66, the pen 36 is held securely and reversibly in the pen holder 2, wherein the fixing takes place in the area of the shaft 42.

### LIST OF REFERENCE SYMBOLS

2 Pen holder
4 Base body
6 First portion
8 Second portion
10 Insertion opening
12 Receiving space
14 Outer surface
16 Holding clip
18, 46 Grip surface
24 First barb
26 Second barb
28 Labeling field
30 Connection area
32, 68 First coupling element
34 First fixing element
36 Pen
38 First end
40 Writing tip
42 Shaft
44 Grip portion
48, 66 Second coupling element
50 Second fixing element
52 Sleeve
54 Thread
56 Cap
58 Sharpener
60 System
62 Base body wall
64 Environment

1-14. (canceled)

15. A pen holder for storing a pen or marker, comprising:
a base body which extends in a longitudinal direction and defines a receiving space for at least partially receiving the pen and has a base body wall,
wherein the base body has an insertion opening in the base body wall at a first end of the longitudinal direction for inserting the pen into the receiving space, at least one first coupling element being formed in or on the base body for reversibly fixing the pen in the receiving space, wherein the first coupling element includes or is a magnetic element or a magnet.

16. The pen holder according to claim 15, wherein the at least one first coupling element is formed distributed over a circumference of the base body.

17. The pen holder according to claim 16, wherein the first coupling element is designed as a ring-shaped coupling element, the coupling element radially enclosing or surrounding the receiving space in sections.

18. The pen holder according to claim 15, wherein the first coupling element is fixed firmly or detachably to the base body via a first fixing element of the base body.

19. The pen holder according to claim 18, wherein the first fixing element includes or is the insertion opening of the base body.

20. The pen holder according to claim 15, wherein the first coupling element forms a sealing section, wherein the sealing section is provided and designed to receive the pen in a sealing manner.

21. A pen, for a pen holder according to claim 15, wherein the pen includes a second coupling element, wherein the second coupling element includes or is a magnetic element or magnet and wherein the second coupling element is designed to be magnetically compatible with the first coupling element.

22. The pen according to claim 21, wherein the second coupling element is formed in or on a grip portion of the pen.

23. The pen according to claim 21, wherein the second coupling element is firmly or detachably fixed to the pen via a second fixing element.

24. The pen according to claim 21, wherein the pen has a writing tip at a first end portion and a cap at a second end portion facing away from the first end portion, wherein the cap has a sharpening device formed on or in an interior space of the cap.

25. The pen according to claim 21, wherein the second coupling element forms a sealing portion, wherein the sealing portion is provided and formed to receive the pen in the pen holder in a sealing manner.

26. A system comprising:
the pen holder according to claim 15; and
a pen,
wherein the pen includes a second coupling element, wherein the second coupling element includes or is a magnetic element or magnet and wherein the second coupling element is designed to be magnetically compatible with the first coupling element, and
wherein the first coupling element and the second coupling element are releasably magnetically connected to each other in an inserted state of the pen in the pen holder and reversibly fix the pen in the pen holder.

27. The system according to claim 26, wherein the first coupling element and the second coupling element form a sealing device and/or, in conjunction with the first and/or second fixing element, form a sealing device which is provided and designed to seal the receiving space from the environment surrounding the system.

28. A method of storing a pen in a pen holder, comprising the steps of:
providing a pen holder having a base body defining a receiving space and including at least one first coupling element, wherein the first coupling element comprises a magnetic element or a magnet;
inserting the pen into the receiving space of the pen holder, wherein the pen includes a second coupling element that is magnetically compatible with the first coupling element; and
reversibly fixing the pen in the receiving space by establishing a magnetic attractive force between the first coupling element and the second coupling element.

29. The method according to claim 28, wherein the step of reversibly fixing the pen includes forming a seal between the first coupling element and the second coupling element to seal the receiving space from an environment.
